(19) United States
(12) Patent Application Publication
(10) Pub. No.: US 2012/0139964 A1
(43) Pub. Date: Jun. 7, 2012

(54) DISPLAY PANEL MODULE AND MULTI-PANEL DISPLAY APPARATUS INCLUDING THE SAME

(75) Inventors: Younho Han, Asan-si (KR); Juhwa Ha, Asan-si (KR); Jinsung Choi, Cheonan-si (KR)

(73) Assignee: SAMSUNG ELECTRONICS CO., LTD., Suwon-si (KR)

(21) Appl. No.: 13/294,331

(22) Filed: Nov. 11, 2011

(30) Foreign Application Priority Data
Dec. 3, 2010 (KR) 10-2010-0122900

(51) Int. Cl. G09G 5/10

(52) U.S. Cl. 345/690; 345/87

(57) ABSTRACT

A display panel module includes a display panel, a lens sheet, and an upper polarizing plate. The display panel includes a display region in which an image is displayed, and a non-display region in which the image is not displayed. The lens sheet faces a light emitting surface of the display panel and changes a path of a portion of light emitted from the display region of the display panel, to transmit the portion of the light onto the non-display region of the display panel. The upper polarizing plate faces a light exiting surface of the lens sheet, and transmits only light traveling parallel to a polarizing axis

This application claims priority to Korean Patent Application No. 10-2010-0122900 filed on Dec. 3, 2010, and all the benefits accruing therefrom under 35 U.S.C. §119, the contents of which are herein incorporated by reference in their entirety.

### BACKGROUND OF THE INVENTION

1. Field of the Invention

The present invention relates to a display panel module and a multi-panel display apparatus including the same. More particularly, the present invention relates to a display panel module and a multi-panel display apparatus capable of displaying images such that a non-display region is not recognized

2. Description of the Related Art

In general, a scheme of displaying one screen image through at least two display panels connected to each other has been adapted to a large-scale display apparatus. In a portable display apparatus, as the performance is improved by adding the wireless internet function, the requirement for a large scale screen has been increased. However, since the portable display apparatus has limitations in size or mobility, a display apparatus equipped with a foldable display has been suggested.

However, in the above display apparatuses, since light is not transmitted through the connection part between two display panels, an image is not displayed in the connection part of the display panels so that a black strip is recognized by a viewer.

### BRIEF SUMMARY OF THE INVENTION

Exemplary embodiments of the present invention provide a display panel module capable of improving display quality by reducing scattered reflection caused by external light.

Exemplary embodiments of the present invention also provide a multi-panel display apparatus including the display panel module.

According to an exemplary embodiment, the display panel module includes a display panel, a lens sheet, and an upper polarizing plate.

The display panel includes a display region in which an image is displayed, and a non-display region in which an image is not displayed. The lens sheet faces a light emitting surface of the display panel and includes at least one lens changing a path of a portion of light transmitted through the display region, and transmits the portion of the light onto the non-display region. The upper polarizing palate faces a light exiting surface of the lens sheet. The upper polarizing plate transmits only light traveling parallel to a polarizing axis.

In an exemplary embodiment, the upper polarizing plate may include a polarizing sheet and an anti-reflective layer to prevent surface reflection caused by external light.

In an exemplary embodiment, the lens may be a Fresnel lens including a plurality of sub lenses. The sub lenses of Fresnel lens may have the same height from the top surface of the display panel, such that a height of the Fresnel lens is constant.

According to another exemplary embodiment, the multi-panel display apparatus includes a plurality of display modules, and each display panel module includes a display panel, a lens sheet, and an upper polarizing plate. Adjacent display panel modules are connected to each other and contact each other at one side thereof Adjacent connected display panel modules define a boundary edge between the adjacent display panel modules.

In an exemplary embodiment, the display panel modules are connected to each other in such a manner that top chassises thereof make contact with each other. Each of the display panel modules may have the structure discussed above.

According to exemplary embodiments, the display panel module includes the lens sheet interposed between the display panel and the upper polarizing plate, thereby reducing scattered reflection caused by external light without performing additional anti-reflection treatment with respect to the lens sheet. Accordingly, since dual anti-reflection treatment is unnecessary, the production cost can be reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is a plan view showing an exemplary embodiment of a multi-panel display apparatus according to the present invention;

FIG. 2 is a cross-sectional view taken along line I-I′ of FIG. 1;

FIG. 3 is a plan view showing another exemplary embodiment of a multi-panel display apparatus according to the present invention;

FIG. 4 is a cross-sectional view taken along line of FIG. 3; and

FIG. 5 is a cross-sectional view showing another exemplary embodiment of a multi-panel display apparatus according to the present invention.

### DETAILED DESCRIPTION OF THE INVENTION

Hereinafter, exemplary embodiments of the present invention will be described in detail with reference to accompanying drawings. However, the present invention is not limited to the following embodiments but includes various changes, substitutions and modifications within the technical scope of the present invention.

Hereinafter, the invention will be described in detail with reference to the accompanying drawings.

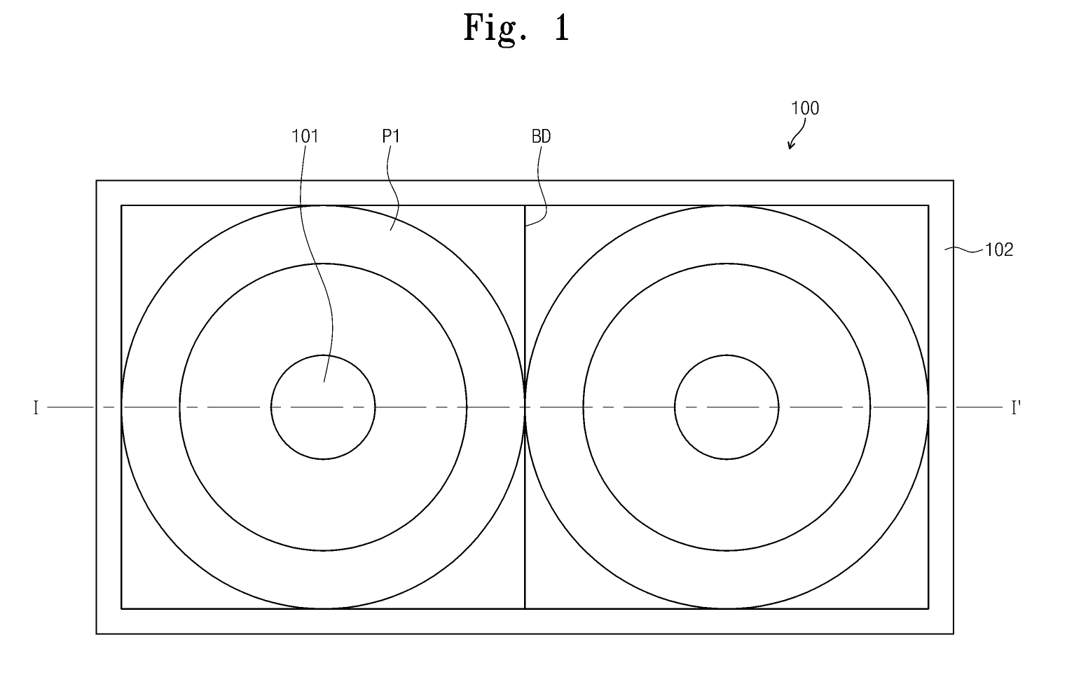

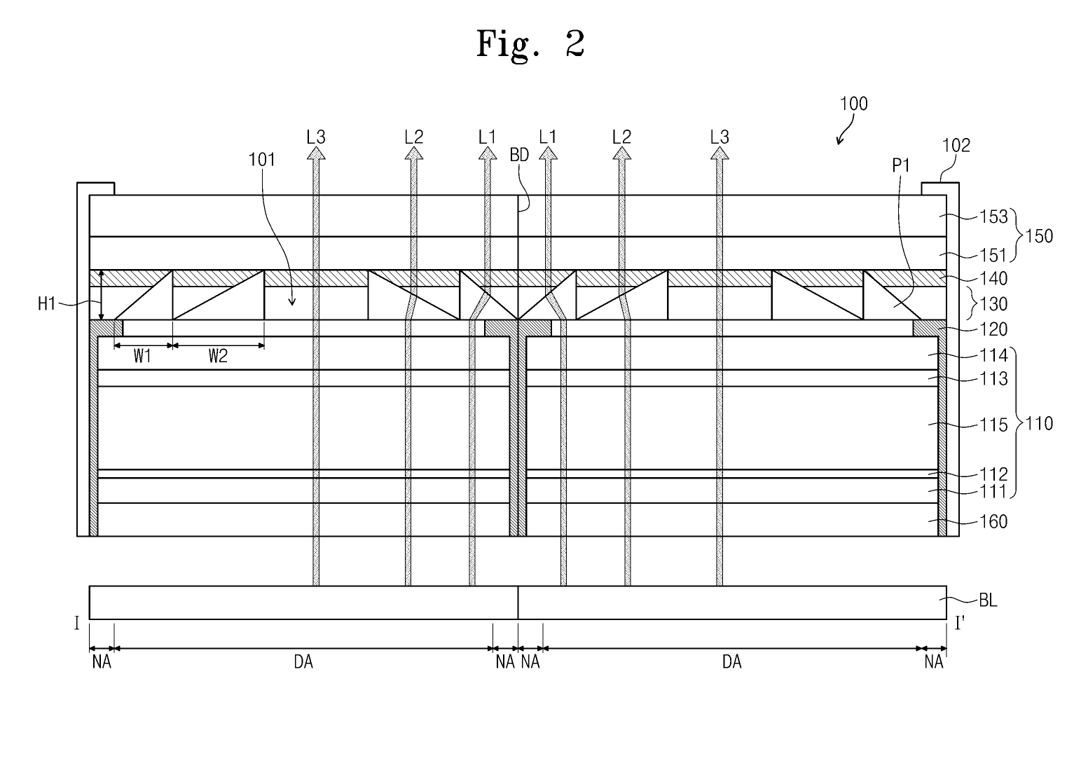

FIG. 1 is a plan view showing an exemplary embodiment of a multi-panel display apparatus according to the present invention, and FIG. 2 is a cross-sectional view taken along line I-I′ of FIG. 1.

Referring to FIGS. 1 and 2, the multi-panel display apparatus 100 includes a plurality of display panel modules, and a frame 102. Each display panel module includes a display panel 110, a lens sheet 130, a top chassis 120, an upper polarizing plate 150 having a first polarizing axis, a lower polarizing plate 160 having a second polarizing axis perpendicular to the first polarizing axis, and a backlight unit BL.

Each display panel module is connected to one adjacent display panel module at one side thereof, or more than one adjacent display panel module at multiple sides thereof. The each display panel module makes contact with the adjacent display panel module, so that a substantially single, continuous screen having a large area can be formed.

According to the illustrated exemplary embodiment, the top chassis 120 of each display panel module is connected to the top chassis 120 of an adjacent display panel module, so that the multi-panel display apparatus 100 can be realized. In one exemplary embodiment, for example, the top chassis 120 of each of a plurality of first display panel modules is provided at one lateral side thereof with a coupling groove, and/or at a second (opposing) lateral side thereof with a protrusion part corresponding to (e.g., aligned with) the coupling groove of a second (adjacent) display panel module, respectively. Therefore, the protrusion part of the first display panel module is coupled with the coupling groove of the second (adjacent) display panel module, so that the first and second display panel modules can be connected to each other.

The number of the display panel modules may be variously employed. Each display panel module may longitudinally extend in a transverse direction to form a single screen longer in the transverse direction, or may longitudinally extend in a longitudinal direction. In the exemplary embodiment of FIGS. 1 and 2, for example, the multi-panel display apparatus 100 includes two display panel modules connected to each other in the transverse direction.

The frame 102 supports and overlaps edges of a front (e.g., viewing side) surface of the multi-panel display apparatus 100. The frame 102 is provided therein with and defines a display window to display images.

The backlight unit BL generates and supplies light to the display panel 110. The backlight unit BL includes a plurality of light sources, or alternatively, one single light source. The light sources may be arranged to overlap substantially a whole rear surface of the display panel 110 opposing the front surface of the multi-display panel apparatus 100. Alternatively, the light sources may be provided only at outer edges of the display panel 110. In addition, the light sources may include one of a light emitting diode (“LED”), a cold cathode fluorescent lamp (“CCFL”), an external electrode fluorescent lamp (“EEFL”), and a heat cathode fluorescent lamp (“HCFL”).

The lower polarizing plate 160 is provided on the rear surface of the display panel 110, and between the backlight unit BL and the display panel 110. The polarizing plate 160 has the second polarizing axis perpendicular to the first polarizing axis of the first polarizing plate 150, such that light directed to the display panel 110 in parallel to the second polarizing axis is transmitted by the lower polarizing plate 160. Although not shown in detail, the lower polarizing plate 160 may include a supporting film and/or a phase difference compensation film.

Although not shown in figures, the multi-panel display apparatus 100 may further include a reflective sheet, which changes paths of light directed in directions other than the direction of the display panel 110 by reflecting the light. The multi-panel display apparatus 100 may further include a diffusion sheet, which diffuses incident light, and a prism sheet, which collects the light diffused in the diffusion sheet in a direction perpendicular to the display panel 110. The reflective sheet, the diffusion sheet and the prism sheet are included between the backlight unit BL and the display panel 110. In addition, the backlight unit BL, the reflective sheet, the diffusion sheet, and the prism sheet may be installed in a receiving container (not shown).

The display panel 110 is prepared in the form of a substantially rectangular plate in the plan view, having shorter and longer sides. The display panel 110 includes a display region DA which displays images, and a non-display region NA that is placed in the vicinity of (e.g., adjacent to) the display region DA and does not display images.

The display panel 110 includes a first substrate 111, a second substrate 114 provided in opposition to the first substrate 111, and a liquid crystal layer 115 interposed between the first and second substrates 111 and 114. A pixel electrode 112 is provided on the first substrate 111 at a rear side of the liquid crystal layer 115, and a common electrode 113 is provided on the second substrate 114 at a front side of the liquid crystal layer 115. In the display panel 110, the alignment of liquid crystal molecules is changed due to the difference between voltages applied to the pixel and common electrodes 112 and 113, so that the transmission of the light supplied from the backlight unit BL is controlled to display images at the front of the multi-panel display apparatus 100.

The first substrate 111 may further include a thin film transistor (not shown) thereon to supply a pixel voltage to the pixel electrode 112. The second substrate 114 may further include a color filter (not shown) thereon. The top chassis 120 is provided on the display panel 110, and a peripheral area of elements of the display panel 110. The top chassis 120 supports and/or contacts edges of a front surface of the display panel 110, and includes the display window to expose the display region DA of the display panel 110.

The lens sheet 130 is directly on the display panel 110 including the top chassis 120. In order attach the lens sheet 130 onto the display panel 110, a first adhesive layer (not shown) may be provided on a rear surface of the lens sheet 130, and directly contacting a portion of an upper surface of the top chassis 120 of the display panel 110.

The lens sheet 130 includes at least one lens. The lens includes a convex lens which magnifies an image displayed in the display region DA, so that the non-display region NA is not recognized. The convex lens protrudes toward the front side of the multi-panel display apparatus 100. In other words, the lens of the lens sheet 130 changes the path of a portion of light transmitted through the display region DA, such that the portion of the light is transmitted to the top surface of the non-display region NA. Accordingly, users cannot recognize the non-display region NA. The detailed operation of the lens will be described later.

According to the illustrated embodiment, the lens includes a Fresnel lens, collectively including a plurality of sub lenses P1. As illustrated in FIG. 2, each sub lens P1 may have a triangular cross-sectional shape, such as a right triangle shape. However, the type and shape of the lens within the lens sheet 130 is not limited thereto. In an alternative embodiment, the lens may include hemispherical shaped lenses, or convex lenses having various curvatures, in the cross-sectional view. When the lens of the lens sheet 130 includes the Fresnel lens, a volume and weight of the lens sheet 130 can be reduced, as compared with a case that the lens includes convex lenses having the same performance. The lens sheet 130 may further include a base sheet having the sub lenses P1 attached thereto.

When viewed in a plan view, the sub lenses P1 are arranged concentrically with respect to a central portion 101 of the display panel 110. A first sub lens P1 is completely within a second sub lens P1, in the plan view. However, the sub lenses P1 are not on or overlapping the central portion 101 of the display panel 110. Although FIG. 1 shows two concentric sub lenses P1 for the purpose of explanation, the present invention is not limited thereto. The lens sheet 130 may include at least two sub lenses P1, or the lens sheet 130 may include more than two sub lenses P1.

As illustrated in FIGS. 1 and 2, the sub lenses P1 are bilaterally-symmetric to each other about a boundary edge BD of the display panel 110, and have the shape of a right-angle triangle when viewed in a cross-sectional view. The sub lenses P1 have inclination angles determined by a height taken from a top surface of the display panel 110, and a width of the sub lens P1 taken parallel to the top surface of the display panel 110.

Each of the sub lenses P1 within one display panel module, and within the multi-panel display apparatus 100, have the same height H1. A width of the sub lens P1 becomes smaller as the sub lens P1 is located further away from the central portion 101. As illustrated in FIG. 2, a width W1 of the sub lens P1 adjacent to the boundary edge BD is smaller than a width W2 of the sub lens P1 nearer to the central portion 101. An incline of each sub lens P1 connects the height and the width, and defines an inclination angle with respect to the width of the sub lens P1 which is taken parallel to the top surface of the display panel 110.

Since the sub lenses P1 all have the same height H1, and since the width W1 of the sub lens P1 adjacent to the boundary edge BD is smaller than a width W2 of the sub lens P1 nearer to the central portion 101, the sub lenses P1 nearer to the central portion 101 have inclination angles smaller than those of the sub lenses P1 nearer to the boundary edge BD. Although the cross section of the sub lenses P1 has the shape of a triangle according to the illustrated exemplary embodiment, the present invention is not limited thereto. In an alternative exemplary embodiment, the sub lenses P1 may have a curved surface protruding away from the top surface of the display panel 110.

Hereinafter, the change of the path of light caused by the lens sheet 130 will be described in detail. For the purpose of explanation, light incident into the sub lens P1 which is adjacent to the boundary edge BD of the display panel 110, through the display panel 110, is referred to as a first light L1, light incident into the sub lenses P1 nearer to the central portion 101 of the display panel 101 than the boundary edge BD is referred to a second light L2, and light passing through the central portion 101 of the display panel 110 is referred to as a third light L3.

Light passing through the display panel 110 is incident into the sub lenses P1, refracted by the sub lenses P1, and output from a respective display panel module. In detail, after the first light L1 has been incident into the sub lens P1 adjacent to the boundary edge BD, the first light L1 is refracted twice by width and inclined surfaces of the sub lens P1, and output through the top surface of the respective display panel module in the non-display region NA. Accordingly, since the first light L1 is output in the non-display region NA, the non-display region NA is effectively not recognized on a front side of the multi-panel display apparatus 100.

The second light L2 is incident into the sub lens P1 adjacent to the central portion 101, refracted twice, and output from the respective display panel module. Since the sub lens P1 adjacent to the central portion P1 has an inclination angle smaller than that of the sub lens P1 adjacent to the boundary edge BD, the second light L2 is refracted less than the first light L1 is refracted. After the second light L2 has been incident into the sub lens P1 adjacent to the central portion 101, the second light L2 is refracted twice by width and inclined surfaces of the sub lens P1, and output through the top surface of the respective display panel module.

Since the sub lens P1 is not arranged at the central portion 101 of the display panel 110, the third light L3 passes directly through the central portion 101 of the display panel 110 and is not refracted.

The upper polarizing plate 150 is provided directly on the lens sheet 130. The upper polarizing plate 150 includes a polarizing sheet 151 and an anti-reflective layer 153.

The polarizing sheet 151 has the first polarizing axis (not shown), and transmits light which is incident into the upper polarizing plate 150 in parallel to the first polarizing axis.

The anti-reflective layer 153 is provided on an outer surface of the polarizing sheet 151 to prevent surface reflection caused by external light. In one exemplary embodiment, for example, the anti-reflective layer 153 may include particles within a polymer resin, and may be formed by injecting the particles into the polymer resin.

Although not shown in figures, the upper polarizing plate 150 may further include a phase difference compensation film interposed between the anti-reflective layer 153 and the polarizing sheet 151. The phase difference compensation film compensates for a side viewing angle of the display panel 110.

A second adhesive layer 140 is provided on a rear surface of the polarizing sheet 151 to attach the lens sheet 130 onto the rear surface of the polarizing sheet 151. The second adhesive layer 140 may include at least one of acrylic, polyester, and polycarbonate-based polymer resin. In addition, although not shown, a portion of the second adhesive layer 140 remains between the rear surface of the polarizing sheet 151 and a top surface of the sub lenses P1, so that the adhesive strength between the polarizing sheet 151 and the sub lenses P1 can be increased. The top surface of the sub lenses P1 may be defined by a portion of the incline, a portion of the height and/or a point at which the incline and height meet.

In each display panel module, the lens sheet 130 is interposed between the display panel 110 and the upper polarizing plate 150, so that scattered reflection caused by external light can be reduced without performing additional anti-reflection treatment with respect to the lens sheet 130. Since the anti-reflection treatment is not required with respect to both of the polarizing plate 150 and the lens sheet 130, the manufacturing cost can be reduced.

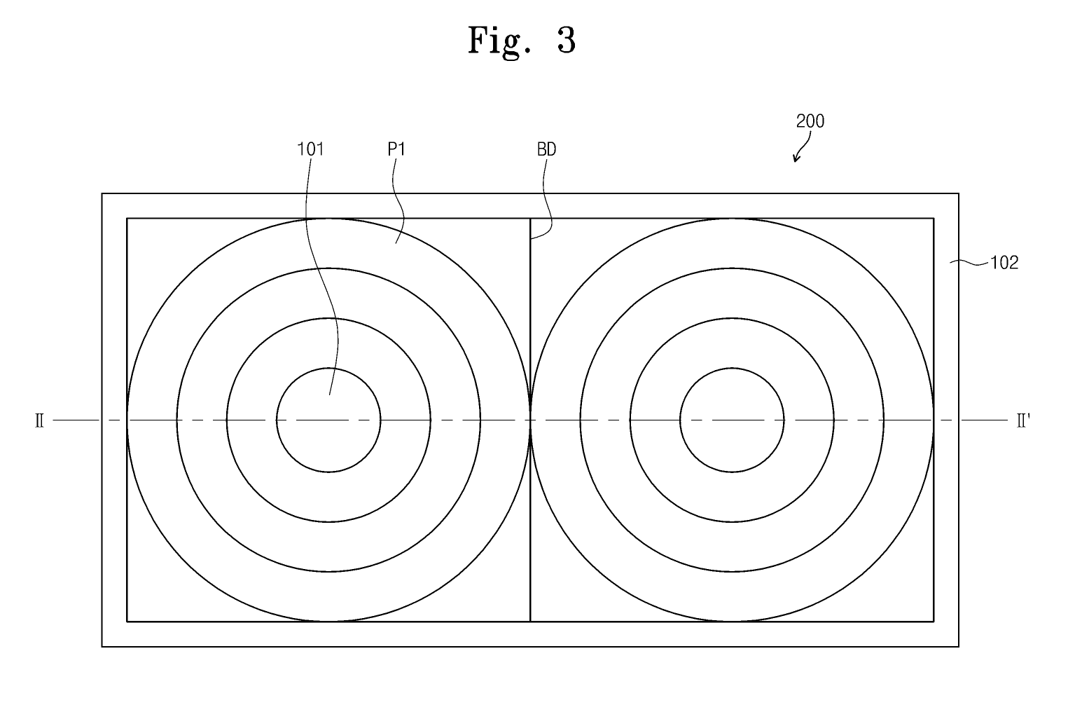

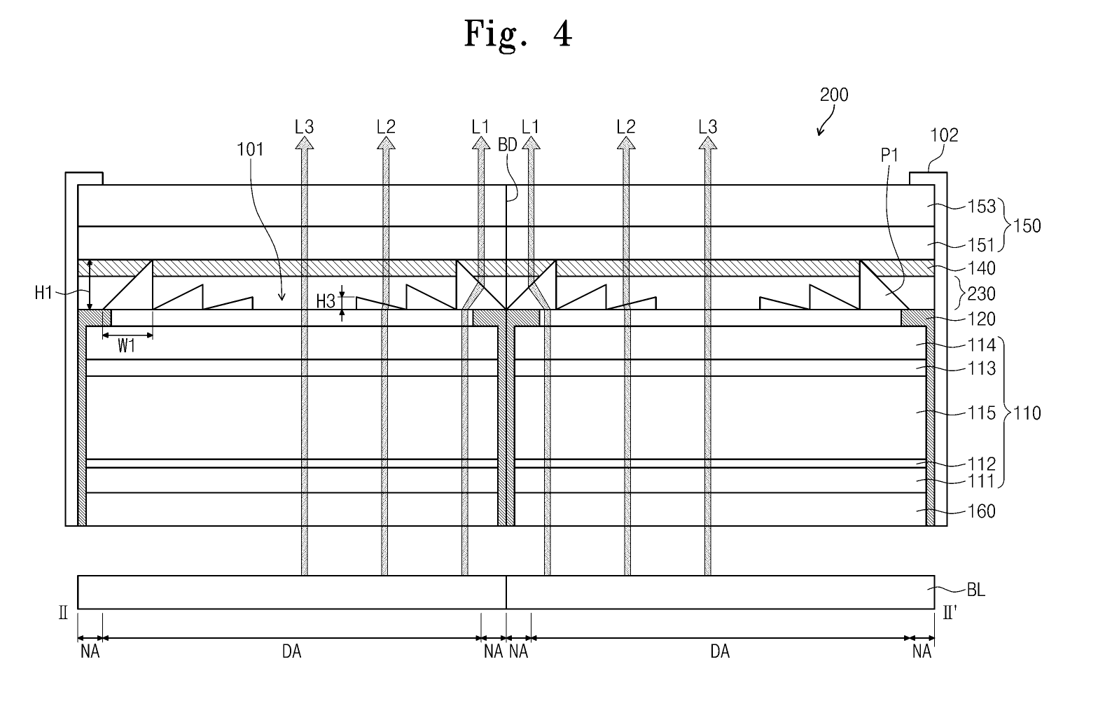

FIG. 3 is a plan view showing another exemplary embodiment of a multi-panel display apparatus 200 according to the present invention, and FIG. 4 is a cross-sectional view taken along line II-I′ of FIG. 3.

Referring to FIGS. 3 and 4, the multi-panel display apparatus 200 includes a plurality of display panel modules, and each display panel module includes the display panel 110, a lens sheet 230, the upper polarizing plate 150, the lower polarizing plate 160, and the backlight unit BL. Since the display panel 110, the upper polarizing plate 150, the lower polarizing plate 160, and the backlight unit BL are identical to those described with reference to FIGS. 1 and 2, the same reference numbers are assigned thereto, and the details thereof will be omitted in order to avoid redundancy.

According to the present embodiment, the lens sheet 230 includes a Fresnel lens collectively including a plurality of sub lenses P1. Since the arrangement and the structure of the sub lenses P1 are similar to those of the exemplary embodiment in FIGS. 1 and 2, the arrangement and the structure of the sub lenses P1 will be described while focusing on the difference from the exemplary embodiment in FIGS. 1 and 2. Although FIGS. 3 and 4 show three sub lenses P1 for the purpose of explanation, the present invention is not limited thereto. The lens sheet 230 may include at least three sub lenses P1, or the lens sheet 230 may include more or less than three sub lenses P1.

Each of the sub lenses P1 within one display panel module, and within the multi-panel display apparatus 100 have the same width, and a height of the sub lenses P1 is increased as the sub lens P1 is located further away from the central portion 101. As illustrated in FIG. 4, a height H1 of the sub lenses P1 nearer to the boundary edge BD is larger than a height H3 of the sub lenses P1 nearer to the central portion 101. An incline of each sub lens P1 connects the height and the width, and defines an inclination angle with respect to the width of the sub lens P1 which is taken parallel to the top surface of the display panel 110.

Since the sub lenses P1 all have the same width W1, and since the height H1 of the sub lens P1 adjacent to the boundary edge BD is larger than a height H3 of the sub lens P1 nearer to the central portion 101, the sub lenses P1 nearer to the central portion 101 have an inclination angle smaller than that of the sub lenses P1 adjacent to the boundary edge BD.

Similar to the previous exemplary embodiment, the first light L1 is refracted twice by width and inclined surfaces of a first sub lens P1 closest to the boundary edge BD, and output through the top surface of a respective display panel module in the non-display region NA, and the second light L2 is refracted twice by width and inclined surfaces of a second sub lens P1 nearer to the central portion 101 than the first sub lens P1, and output through the top surface of the respective display panel module. Consequently, portions of the light output from the display panel 110 are refracted and redirected by the lens sheet 230 towards the boundary edge BD, and the non-display region NA is effectively not recognized on a front side of the multi-panel display apparatus 200.

In order to prevent the photorefractive characteristic of light passing through the sub lenses P1 from being changed when the light is incident into the upper polarizing plate 150, a material having a refractive index different from that of the sub lenses P1 may be between adjacent sub lenses P1, and between the sub lenses P1 and the upper polarizing plate 150. Although the cross-section of the patterns constituting the sub lenses P1 of the Fresnel lens has the shape of a plurality of triangular prism mountains according to the illustrated exemplary embodiment, the present invention is not limited thereto. The cross-section of the patterns may have a curved surface.

Similarly to the exemplary embodiment in FIGS. 1 and 2, the multi-panel display apparatus 200 includes the lens sheet 230 between the display panel 110 and the upper polarizing plate 150, so that scattered reflection caused by external light can be reduced without performing additional anti-reflection treatment with respect to the lens sheet 230. In other words, since the anti-reflection treatment is not required with respect to both of the polarizing plate 150 and the lens sheet 130, the manufacturing cost can be reduced.

In addition, since the interval between the polarizing sheet 151 and the lens sheet 230 is maintained by a portion of the sub lens P1, the sub lenses P1 may have the shape of a perfect prism mountain. The portion of the sub lens P1 maintaining the interval between the polarizing sheet 151 and the lens sheet 230 may be defined by a height of the sub lens P1, and/or portions of the incline and the height adjacent to the point at which the incline and point meet, and the point itself Therefore, the refraction by the sub lenses P1 is superior to that of the sub lenses according to the previous exemplary embodiment.

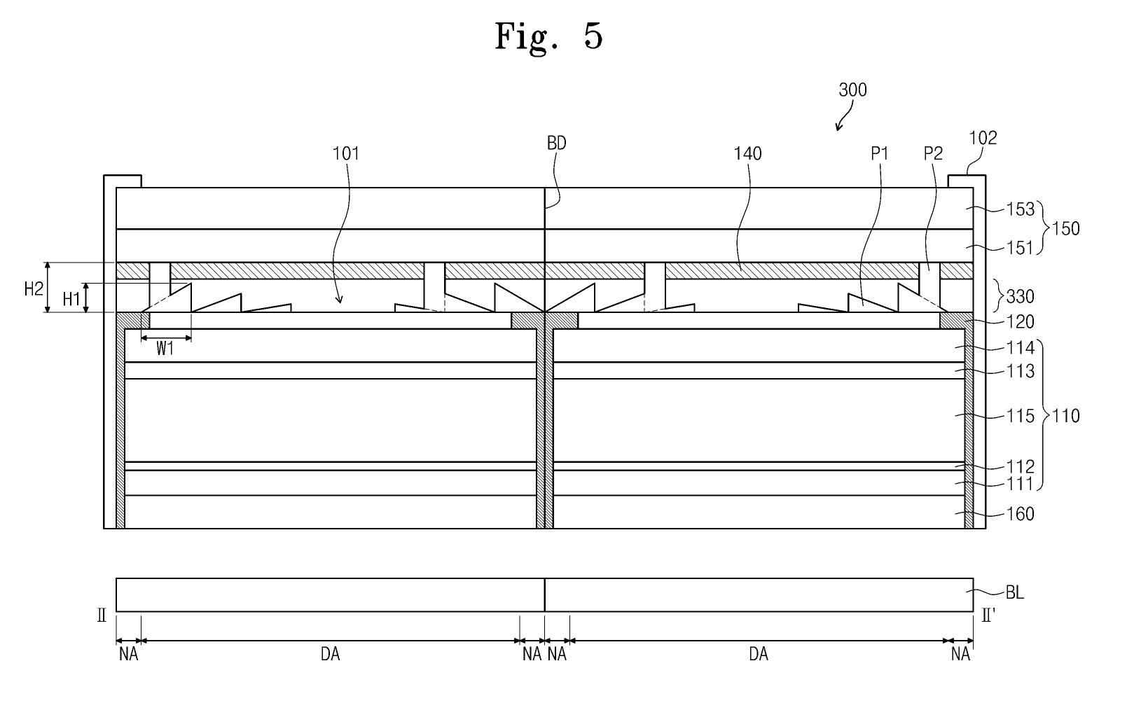

FIG. 5 is a cross-sectional view showing another exemplary of a multi-panel display apparatus 300 according to the present invention.

Referring to FIG. 5, the multi-panel display apparatus 300 includes a plurality of display panel modules, and each display panel module includes the display panel 110, a lens sheet 330, the upper polarizing plate 150, the lower polarizing plate 160, and the backlight unit BL. Since the display panel 110, the upper polarizing plate 150, the lower polarizing plate 160, and the backlight unit BL are identical to those described with reference to FIGS. 1 and 2, the same reference numbers are assigned thereto, and the details thereof will be omitted in order to avoid redundancy.

The lens sheet 330 includes a plurality of sub lenses P1 and bonding parts P2 collectively constituting a Fresnel lens. When viewed in a plan view, the sub lenses P1 are arranged concentrically with respect to the central portion 101 of the display panel 110. However, the sub lenses P1 are not on the central portion 101 of the display panel 110. The sub lenses P1 have inclination angles determined by a first height H1 thereof taken from the top surface of the display panel 110, and a width W1 thereof taken parallel to the top surface of the display panel 110.

As indicated by the dotted lines in FIG. 5, the bonding parts P2, and the sub lenses P1 to which the bonding parts P2 are directly connected, collectively form a single unitary indivisible element. An entire of the sub lenses P1 and the bonding parts P2 collectively forming the Fresnel lens may be a single unitary indivisible element.

The sub lenses P1 are bilaterally-symmetric to each other about a boundary edge BD of the display panel 110, and have the shape of a right-angle prism mountain when viewed in a cross-sectional view.

Each of the sub lenses P1 within one display panel module, and within the multi-panel display apparatus 300, have the same width W1, and a first height H1 of the sub lenses P1 is increased as the sub lens P1 is located further away from the central portion 101. As illustrated in FIG. 5, the first height H1 of the sub lenses P1 nearer to the boundary edge BD is larger than that of the sub lens P1 nearer to the central portion 101. An incline of each sub lens P1 connects the height and the width, and defines an inclination angle with respect to the width of the sub lens P1 which is taken parallel to the top surface of the display panel 110.

Since the sub lenses P1 all have the same width W1, and since the first height H1 of the sub lens P1 adjacent to the boundary edge BD is larger than a height of the sub lens P1 nearer to the central portion 101, the sub lenses P1 nearer to the central portion 101 have inclination angles smaller than that of the sub lenses P1 adjacent to the boundary edge BD.

Although the cross-section of the sub lenses P1 constituting the Fresnel lens has the shape of a plurality of right-angle prism mountains, the present invention is not limited thereto. Alternatively, the sub lenses P1 may have a curved surface.

The bonding parts P2 of the lens sheet serve as spacers maintaining an interval between the polarizing sheet 151 and the lens sheet 330. The bonding parts P2 have a second height H2 taken from the top surface of the display panel 110, and the second height H2 is larger than a maximum height the first heights H1 of the sub lens P1.

A top surface of each bonding part P2 is parallel to the rear surface of the polarizing sheet 151 such that the bonding part P2 can easily adhere to the polarizing sheet 151. The top surface of the bonding part P2 contacts the rear surface of the polarizing sheet 151. The bonding part P2 may have various shapes such as a cylindrical shape, a polygonal prism shape, an oval shape, a truncated conical shape, and a truncated polygonal pyramid shape.

The bonding parts P2 may be at a regular interval or an irregular interval on a front surface of the lens sheet 330. The bonding parts P2 maintain the interval between the lens sheet 330 and the polarizing sheet 151. Accordingly, a minimum number of the bonding parts P2 to maintain the interval between the polarizing sheet 151 and the lens sheet 330 is provided, so that the refraction of the sub lenses P1 can be maximized. The sub lenses P1 and the bonding parts P2 of the lens sheet 330 may include the same material and/or may be integrated with each other so as to collective form the single unitary indivisible lenses of the lens sheet 330.

Similar to the exemplary embodiment in FIGS. 3 and 4, in order to prevent the photorefractive characteristic of light passing through the sub lenses P1 from being changed when the light is incident into the upper polarizing plate 150, a material having a refractive index different from that of the sub lenses P1 may be between adjacent sub lenses P1, and between the sub lenses P1 and the upper polarizing plate 150.

Since the operation of the lens sheet 330 according to the illustrated exemplary embodiment is similar to that of the lens sheet 230 described with reference to FIGS. 3 and 4, the detailed description of the lens sheet 330 may be omitted.

Similar to the exemplary embodiment in FIGS. 1 and 2, the second adhesive layer 140 is interposed between the polarizing sheet 151 and the sub lenses P1, so that a portion of the sub lenses P1 can adhere to the upper polarizing plate 150. The portion of the sub lenses P1 may be defined by a portion of the incline, a portion of the height and/or a point at which the incline and height meet. The second adhesive layer 140 may include at least one of acrylic, polyester, and polycarbonate-based polymer resin. In addition, although not shown, a portion of the second adhesive layer 140 remains between the rear surface of the polarizing sheet 151 and the top surface of the bonding part P2, so that the adhesive strength between the upper polarizing sheet 151 and the sub lenses P1 can be increased.

As described above, in the multi-panel display apparatus 300, the lens sheet 330 is interposed between the display panel 110 and the upper polarizing plate 150, so that scattered reflection caused by external light can be reduced without performing additional anti-reflection treatment with respect to the lens sheet 330. In comparison to the exemplary embodiment in FIGS. 3 and 4, since the adhesive strength with the polarizing sheet 151 can be improved due to the bonding parts P2, the reliability of the lens sheet 330 can be improved.

Although exemplary embodiments of the present invention have been described, it is understood that the present invention should not be limited to these exemplary embodiments, but various changes and modifications can be made by one ordinary skilled in the art within the spirit and scope of the present invention as hereinafter claimed.

What is claimed is:

1. A display panel module comprising:
a display panel comprising a display region in which an image is displayed, and a non-display region adjacent to the display region and in which the image is not displayed;
a lens sheet facing a light emitting surface of the display panel and comprising at least one lens, wherein the lens changes a path of a portion of light emitted from the display region of the display panel and transmits the portion of the emitted light through a light exiting surface and onto the non-display region of the display panel; and
an upper polarizing plate facing the light exiting surface of the lens sheet, wherein the upper polarizing plate transmits only light traveling parallel to a polarizing axis.

2. The display panel module of claim 1, wherein the upper polarizing plate comprises an anti-reflective layer which reduces surface reflection caused by external light.

3. The display panel module of claim 1, wherein the lens comprises a Fresnel lens comprising a plurality of sub lenses.

4. The display panel module of claim 3, wherein the sub lenses include inclined surfaces symmetric to each other about a central portion of the display panel, and are concentrically arranged about the central portion of the display panel in a plan view.

5. The display panel module of claim 3, wherein heights of the sub lenses are identical to each other, and a width of a sub lens nearer to a central portion of the display panel is larger than a width of a sub lens nearer an outer edge of the display panel, the widths taken parallel to a top surface of the display panel.

6. The display panel module of claim 3, wherein
widths of the sub lenses are identical to each other, and
a height of a sub lens nearer to a central portion of the display panel is smaller than a height of a sub lens nearer an outer edge of the display panel, the heights taken perpendicular to a top surface of the display panel.

7. The display panel module of claim 6, wherein the lens sheet further comprises bonding parts having a height larger than a maximum height of the sub lenses.

8. The display panel module of claim 1, further comprising a backlight unit facing a rear surface of the display panel, wherein the backlight unit generates and supplies light to the display panel.

9. The display panel module of claim 1, wherein the display panel comprises a liquid crystal display panel.

10. A multi-panel display apparatus comprising:
a plurality of display panel modules connected to each other, wherein the connected display modules contact each other on at least one side thereof and define a boundary edge between the connected display panel modules, each display panel module comprising:
a display panel comprising a display region in which an image is display, and a non-display region adjacent to the display region and in which the image is not displayed;
a lens sheet facing a light emitting surface of the display panel and comprising at least one lens, wherein the lens changes a path of a portion of light emitted from the display region of the display panel and transmits the portion of the emitted light through a light exiting surface and onto the non-display region of the display panel; and
an upper polarizing plate facing the light exiting surface of the lens sheet, wherein the upper polarizing plate transmits only light traveling parallel to a first polarizing axis.

11. The multi-panel display apparatus of claim 10, wherein the lens comprises a Fresnel lens comprising a plurality of sub lenses.

12. The multi-panel display apparatus of claim 11, wherein the sub lenses of each display panel module include inclined surfaces symmetric to each other about the boundary edge between the connected display panel modules, and are concentrically arranged about a central portion of the display panel in a plan view.

13. The multi-panel display apparatus of claim 12, wherein within each display panel module,
heights of the sub lenses are identical to each other, and
a width of a sub lens nearer to the central portion of the display panel is larger than a width of a sub lens nearer to the boundary edge between the connected display panel modules, the widths taken parallel to a top surface of the display panel.

14. The multi-panel display apparatus of claim 12, wherein within each display panel module,
widths of the sub lenses are identical to each other, and
a height of a sub lens nearer to the central portion of the display panel is smaller than a height of a sub lens nearer to the boundary edge between the connected display panel modules, the heights taken perpendicular to a top surface of the display panel.

15. The multi-panel display apparatus of claim 14, wherein the lens sheet further comprises bonding parts having a height larger than a maximum height of the sub lenses.

16. The multi-panel display apparatus of claim 10, wherein the upper polarizing plate comprises an anti-reflective layer which reduces surface reflection caused by external light.

17. The multi-panel display apparatus of claim 10, wherein the display panel comprises a liquid crystal display panel.

18. The multi-panel display apparatus of claim 10, further comprising a backlight unit facing a rear surface of the display panel, wherein the backlight unit generates and supplies light to the display panel.

19. The multi-panel display apparatus of claim 18, further comprising a lower polarizing plates facing the rear surface of the display panel, between the backlight unit and the rear surface of the display panel, and having a second polarizing axis perpendicular to the first polarizing axis of the upper polarizing plate.

20. A method of displaying images of a multi-panel display apparatus, the method comprising:
providing light to a display panel of each of a plurality of display panel modules, wherein adjacent display panel modules contact each other at facing sides thereof, the contacted sides defining a boundary between the adjacent display panel modules;
emitting the light in a first direction through a display area of the display panels;
refracting a portion of the emitted light by a plurality of lenses of each of the display panels, and transmitting the refracted portion of the light in a second direction different than the first direction through the lenses, the second direction being towards the boundary between the adjacent display panel modules; and
exiting the refracted portion of light overlapping a non-display area of the display panels to display the images of the multi-panel display apparatus,
wherein each of the display panel modules comprises:
a lens sheet facing a light emitting surface of the display panel and comprising the plurality of lenses; and
an upper polarizing plate facing a light exiting surface of the lens sheet, wherein the upper polarizing plate transmits only light traveling parallel to a polarizing axis.
